(19) United States
(12) Patent Application Publication
(10) Pub. No.: US 2014/0170412 A1
(43) Pub. Date: Jun. 19, 2014

(54) INSULATING COMPOSITION, SUBSTRATE INCLUDING INSULATING LAYER USING THE SAME, AND METHOD FOR MANUFACTURING THE SUBSTRATE

(71) Applicant: SAMSUNG ELECTRO-MECHANICS CO., LTD., Suwon (KR)

(72) Inventors: Soo Young JI, Suwon (KR); Shang Hoon Seo, Suwon (KR); Suk Jin Ham, Suwon (KR); Seung Hwan Kim, Suwon (KR)

(73) Assignee: SAMSUNG ELECTRO-MECHANICS CO., LTD., Suwon (KR)

(21) Appl. No.: 13/827,374

(22) Filed: Mar. 14, 2013

(30) Foreign Application Priority Data
Dec. 18, 2012 (KR) 10-2012-0148507

(51) Int. Cl. C09D 7/12; B05D 7/24

(52) U.S. Cl. CPC C09D 7/1233; B05D 7/24
USPC 428/332; 106/287.24; 106/287.25; 106/287.22; 106/287.2; 106/287.17; 106/287.16; 524/104; 427/427.4; 427/421.1; 428/688

(57) ABSTRACT

An insulating composition including a graphene oxide and an insulating material including the same; and a polar solvent having a solvent polarity index (P) of greater than 5.5, a substrate including an insulating layer using the same, and a method for manufacturing the substrate. It is possible to provide an insulating composition including a specific solvent that can secure dispersibility of the graphene oxide while including the graphene oxide having excellent insulating and mechanical properties as an insulating material. Further, it is possible to provide a substrate including a fine insulating layer pattern as well as a bulk insulating layer pattern by using the insulating composition to overcome an aggregation problem in a conventional inkjet printing method.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2012-0148507, entitled filed Dec. 18, 2012, which is hereby incorporated by reference in its entirety into this application.”

### BACKGROUND OF THE INVENTION

1. Field of the Invention

The present invention relates to an insulating composition, a substrate including an insulating layer using the same, and a method for manufacturing the substrate.

2. Description of the Related Art

With the advance of electronic devices, electronic components are becoming lighter, thinner, and smaller day by day. In order to meet these requirements, printed circuit wiring of the electronic components is becoming more complicated and densified.

Currently, most of the printed circuit wiring is formed by a common casting method but there are limitations since it is not easy to implement a fine pattern by the casting method.

Therefore, there are many attempts to apply nano- and microparticles to printed electronics, and it is possible to print an ultrafine line width pattern according to miniaturization and thinning of the electronic components (RFID tags, PCB substrates, electrodes for PDP, etc) by using the nano- and microparticles.

Generally, the fine patterns are largely classified into an electrode layer for configuring a circuit and an insulating layer for electrical insulation.

In order to implement a fine pattern circuit, the electrode layer requires a process of dispersing metal nanoparticles in a specific solvent. The process at this time is performed by putting the manufactured metal nanoparticles in a specific solvent and stirring them while applying a constant temperature. However, this conventional method causes aggregation of the metal nanoparticles due to unstable dispersibility of the conductive nano metal.

Even in case of the insulating layer, an insulating material (for example, a polymer), which is well dispersed in a solvent, should be used and maintain a viscosity, which is not high, to be discharged.

As the conventional method of forming an insulating layer pattern, a method of forming an insulating layer pattern by compressing, drilling or exposing, and stripping an insulating film has been commonly used.

### RELATED ART DOCUMENT

### Patent Document

Patent Document 1: Korean Patent Laid-Open No. 2012-032871

### SUMMARY OF THE INVENTION

The present invention has been invented in order to overcome the above-described problems and it is, therefore, an object of the present invention to provide an insulating composition that can overcome the problems of the prior art by specifying a solvent having excellent compatibility with a graphene oxide to secure dispersibility of the graphene oxide in using the graphene oxide, which has excellent insulating characteristics and mechanical properties, as an insulating material.

Further, it is another object of the present invention to provide a printed circuit board including an insulating layer pattern formed of an insulating composition.

Further, it is still another object of the present invention to provide a method for manufacturing a printed circuit board that can form an insulating layer pattern by an inkjet printing method using an insulating composition including a stably dispersed graphene oxide.

In accordance with one aspect of the present invention to achieve the object, there is provided an insulating composition including: a graphene oxide and an insulating material including the same; and a polar solvent having a solvent polarity index (P) of greater than 5.5.

It is preferred that an average particle size of the graphene oxide is 10 nm to 50 μm.

The graphene oxide may have at least one functional group among a hydroxyl group, a carboxyl group, and an epoxy group on its surface and edge.

It is preferred that a ratio of carbon atoms to oxygen atoms (carbon/oxygen ratio) of the graphene oxide is 1 to 20.

In accordance with an embodiment of the present invention, the polar solvent may include one or more functional groups selected from nitrile, oxide, amide, pyrrolidone, sulfoxide, and diol.

In accordance with an embodiment of the present invention, the polar solvent may be one or more selected from the group consisting of acetonitrile, tetrahydrofuran (THF), acetic acid, dimethylformamide (DMF), N-methylpyrrolidone (NMP), dimethyl sulfoxide (DMSO), ethylene glycol, and water.

The insulating composition may have a viscosity of less than 250 cps at room temperature (25° C.).

In accordance with an embodiment of the present invention, the insulating material may include one or more selected from a soluble liquid crystal thermosetting oligomer, an inorganic filler, a metal alkoxide, and a short fiber.

The soluble liquid crystal thermosetting oligomer may be a compound represented by the following chemical formula 2.

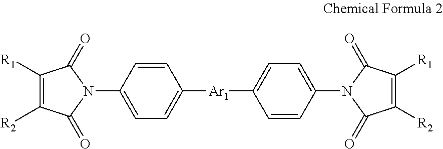

In the formula, R₁ and R₂ are CH₃ or H, and at least one of R₁ and R₂ is CH₃.

Ar₁ is a bivalent aromatic organic group having a molecular weight of less than 5,000, which includes one or more structural units selected from the group consisting of ester, amide, ester amide, ester imide, and ether imide.

Ar₁ includes one or more structural units selected from the group represented by the following chemical formula 3.

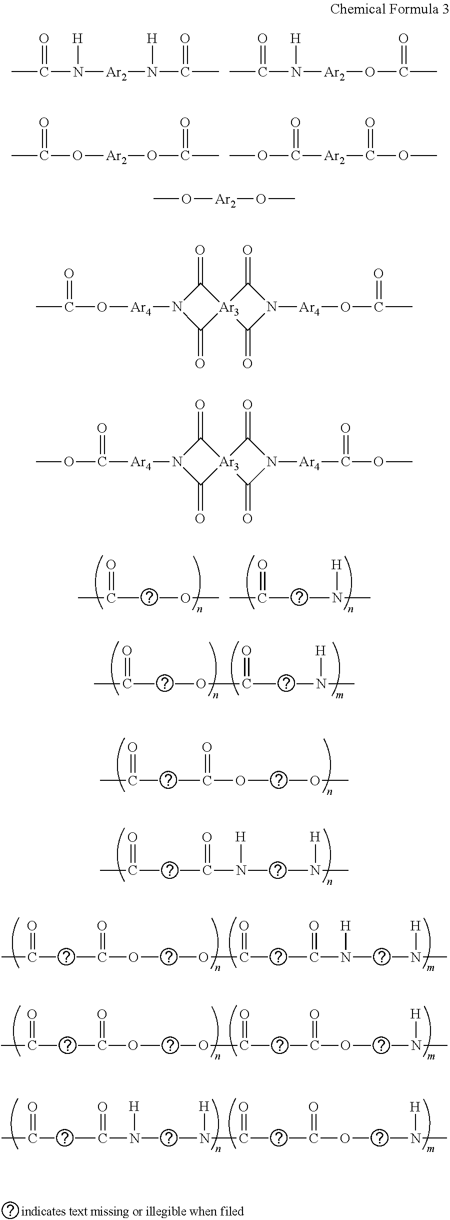

In the formula, Ar₂, Ar₄, Ar₅, and Ar₆ are bivalent aromatic organic groups and include one or more structural units selected from the group represented by the following chemical formula 4.

Ar₃ is a tetravalent aromatic organic group and includes one or more structural units selected from the group represented by the following chemical formula 5.

n and m are integers from 1 to 100.

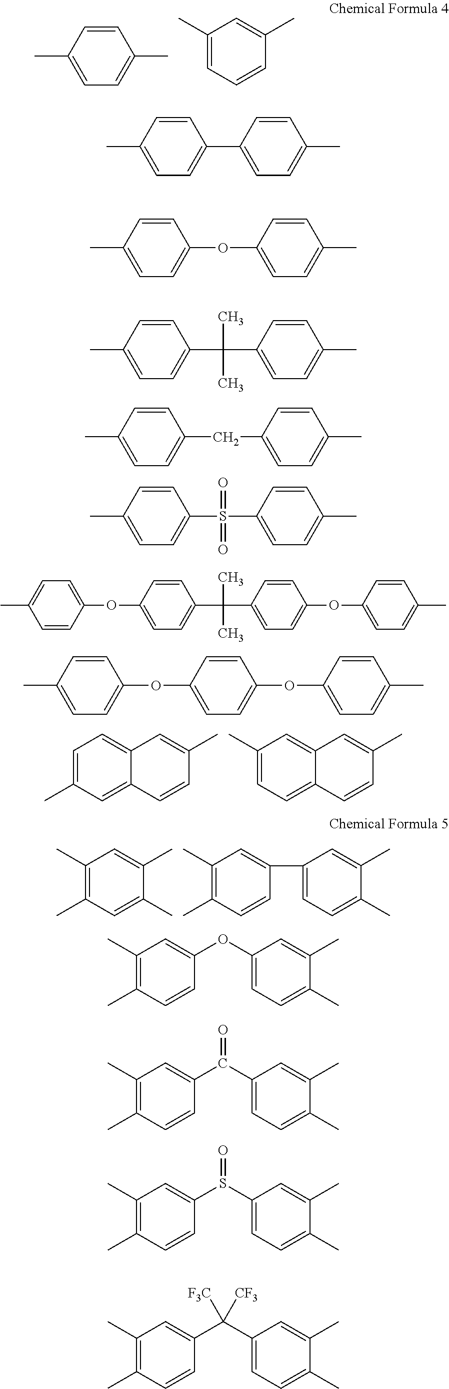

It is preferred that a number average molecular weight of the soluble liquid crystal thermosetting oligomer is 500 to 15,000.

The soluble liquid crystal thermosetting oligomer may additionally include an epoxy resin in a main chain.

The epoxy resin may be included in an amount of 0.01 to 50 parts by weight based on 100 parts by weight of the soluble liquid crystal thermosetting oligomer.

Further, a metal of the metal alkoxide may be one or more selected from the group consisting of Ti, Al, Ge, Co, Ca, Hf, Fe, Ni, Nb, Mo, La, Re, Sc, Si, Ta, W, Y, Zr, and V.

Further, the short fiber may have an average fiber length of 5 nm to 1000 μm.

The short fiber may be one or more selected from the group consisting of glass fibers, Kevlar, carbon fibers, and alumina.

Further, in accordance with another aspect of the present invention to achieve the object, there is provided a substrate including an insulating layer using an insulating composition including a graphene oxide and an insulating material including the same; and a polar solvent having a solvent polarity index (P) of greater than 5.5.

A thickness of the insulating layer may be 5 nm to 1000 μm.

Further, the insulating layer may be an insulating prepreg or an insulation film.

Further, in accordance with still another aspect of the present invention to achieve the object, there is provided a method for manufacturing a substrate including the step of forming an insulating layer by using an insulating composition including a graphene oxide and an insulating material including the same; and a polar solvent having a solvent polarity index (P) of greater than 5.5.

It is preferred that the insulating layer is formed by an inkjet printing method.

The insulating composition may have a viscosity of less than 250 cps at room temperature (25° C.).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 a schematic diagram of a process of manufacturing a graphene oxide in accordance with the present invention;

FIG. 2 shows the measurement results of dispersibility according to solvents of a graphene oxide;

FIG. 3 is a graph measuring thermal characteristics and coefficients of thermal expansion of films according to an embodiment 1, a comparative example 2, and a reference example;

FIG. 4 is a graph measuring thermal characteristics and coefficient of thermal expansion of a film according to a comparative example 1; and

FIGS. 5 and 6 show the results of observing whether printing of an insulating layer formed according to each embodiment and a substrate including the same is actually implemented.

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to an insulating composition, which can be used in a substrate etc, a substrate including an insulating layer using the composition, and a method for manufacturing the substrate.

An insulating composition in accordance with the present invention may include a graphene oxide and an insulating material including the same; and a polar solvent having a solvent polarity index (P) of greater than 5.5.

The graphene oxide is characterized by a low coefficient of thermal expansion and excellent mechanical characteristics. It is possible to improve characteristics of a polymer resin only by adding a smaller amount of the graphene oxide than an inorganic filler such as silica, which is generally added to improve mechanical strength of the polymer resin as an insulating material.

Further, unlike graphene having conductivity, the graphene oxide can be also used as an insulating material that can improve insulating properties. However, in order to use the graphene oxide as an insulating material, it is important to secure dispersibility in the insulating composition.

The graphene oxide in accordance with the present invention may be prepared by oxidizing graphite by the same process as FIG. 1, and an oxidizing agent is not limited thereto. For example, KMnO₄, H₂SO₄, HNO₃, KClO₃, H₂CrO₄, etc. may be used as the oxidizing agent, and one or a mixture of two or more of them may be used as the oxidizing agent.

Graphite has a layered structure in which graphene having a plate structure formed by connecting carbon atoms in a hexagonal ring is stacked. Generally, since graphite has a structure in which a distance between the layers is 3.35 Å and carbon nanotubes are spread in plate state, graphite has high conductivity corresponding to carbon nanotube and excellent mechanical properties.

When graphite powder is oxidized, graphene oxide powder, which has at least one functional group of a hydroxyl group, a carboxyl group, and an epoxy group attached to its surface and edge while maintaining a layered structure, is obtained by oxidizing each layer of graphite.

In the present invention, a graphite oxide having a layered structure may be exfoliated in water or dissolved in another solvent.

It is preferred that the graphene oxide in accordance with the present invention is sufficiently oxidized not to deteriorate the insulating properties of the polymer resin. That is, it is preferred that the graphene oxide in accordance with the present invention is sufficiently oxidized to hardly exhibit electrical conductivity characteristics or completely lose the electrical conductivity characteristics. For this, it is preferred that a ratio of carbon atoms to oxygen atoms of the graphene oxide may change according to the degree of oxidization, for example, preferably 1 to 20.

The excellent insulating properties of the graphene oxide are given from oxygen and the functional groups on the surface and edge of the graphene oxide. Since the surface oxygen and the chemical functional groups of the graphene oxide can't be removed except by a thermal reduction process at over 1000° C. or a reduction process using a reducing agent, the graphene oxide can maintain the excellent insulating properties. The functional groups on the surface and edge of the graphene oxide may be a hydroxyl group, an epoxy group, a carboxyl group, etc, and the kind and number of the functional groups may be different according to an oxidization method or the degree of oxidization.

All of the graphene oxides represented by the following chemical formula 1, such as Hofmann, Ruess, Scholz-Boehm, and Nakajima-Mastsuo, may be used as the graphene oxide in accordance with the present invention, and the kind thereof is not particularly limited.

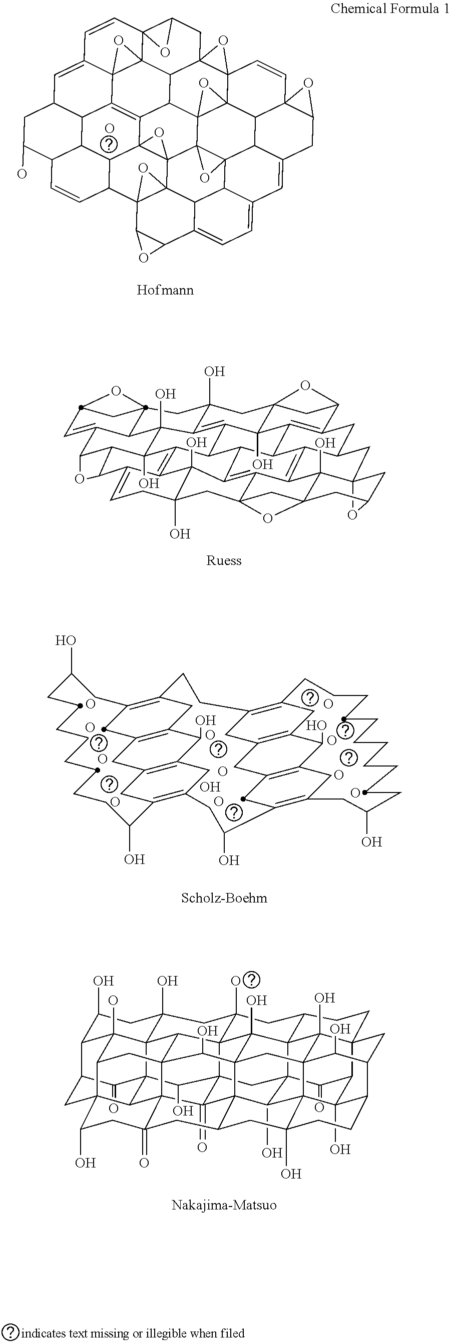

By noticing that the graphene oxide in accordance with the present invention after the above process has a surface charge distribution in a specific solvent, the polar solvent having a solvent polarity index of greater than 5.5 is used to prevent aggregation of the graphene oxide and secure the excellent dispersibility of the graphene oxide in the insulating composition.

The polar solvent in accordance with an embodiment of the present invention may include one or more functional groups selected from nitrile, oxide, amide, pyrrolidone, sulfoxide, and diol.

Since the solvent including the above functional group has a polarity index of greater than 5.5, it is advantageous to dispersion due to good compatibility with the graphene oxide.

For a concrete example, the polar solvent of the present invention may be one or more selected from the group consisting of acetonitrile, tetrahydrofuran (THF), acetic acid, dimethylformamide (DMF), N-methylpyrrolidone (NMP), dimethyl sulfoxide (DMSO), ethylene glycol, and water.

In the present invention, it is preferred that the solvent having a polarity index of greater than 5.5 is included at a concentration of 3 to 85 wt % based on a weight ratio of the graphene oxide. When the content of the solvent is less than 3 wt %, it may be difficult to implement a viscosity of less than 250 cps@25° C. (room temperature), which can be derived by an inkjet method, and a small insulation thickness of less than several to hundreds of nm. When exceeding 85 wt %, a process delay may occur due to an increase in solvent drying time, and a process time may increase due to an increase in the number of ink jetting for implementing an insulation thickness having continuity.

Further, in the present invention, a hydrophilic dispersant may be selectively included in an amount of less than 50 wt % based on the weight of the graphene oxide to improve the dispersibility of the graphene oxide. For example, the dispersant may be anionic dispersants such as carboxylate, sulfonate, sulfate, and phosphate; cationic dispersants such as quaternary ammonium salt and pyridinium salt; nonionic dispersants such as polyethylene glycol and polyhydric alcohol; or amphoteric dispersants such as betaine, sulfobetaine, and amino acid, but not particularly limited thereto.

In accordance with an embodiment of the present invention, the insulating material of the insulating composition of the present invention may be at least one selected from a soluble liquid crystal thermosetting oligomer, a metal alkoxide, and a short fiber, in addition to the graphene oxide.

The soluble liquid crystal thermosetting oligomer may be a compound represented by the following chemical formula 2.

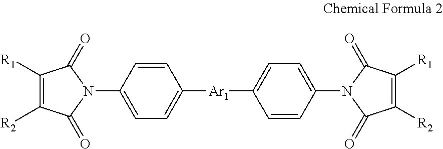

In the formula, R₁ and R₂ are CH₃ or H, and at least one of R₁ and R₂ is CH₃.

Ar₁ is a bivalent aromatic organic group with a molecular weight of less than 5,000, which includes one or more structural units selected from the group consisting of ester, amide, ester amide, ester imide, and ether imide.

Ar₁ includes one or more structural units selected from the group represented by the following chemical formula 3.

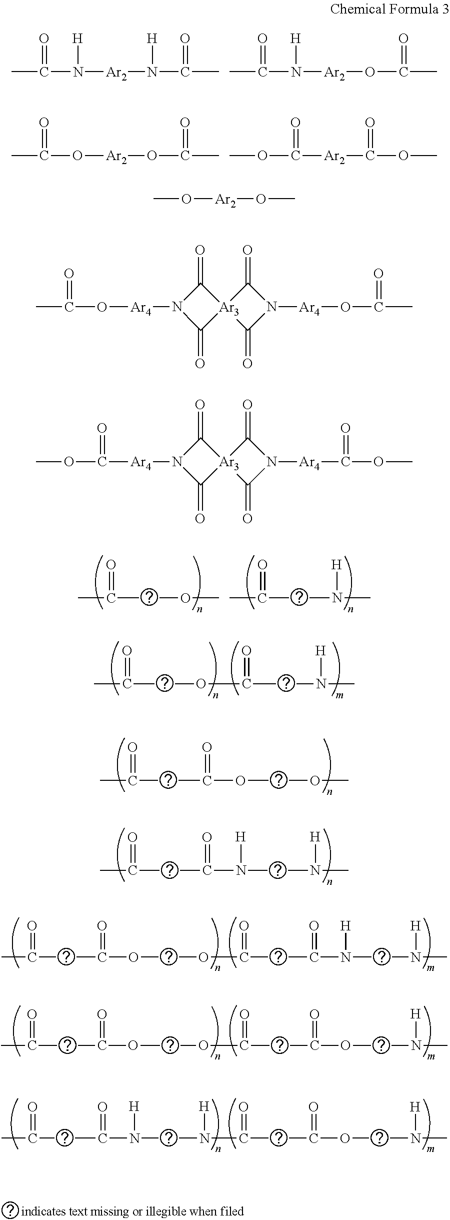

In the formula, Ar₂, Ar₄, Ar₅, and Ar₆ are bivalent aromatic organic groups and include one or more structural units selected from the group represented by the following chemical formula 4.

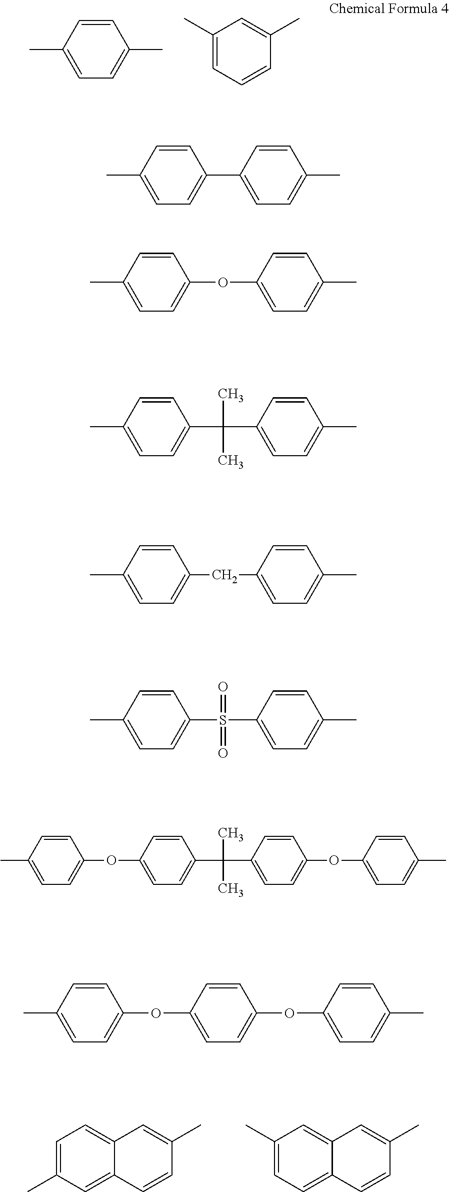

Ar₃ is a tetravalent aromatic organic group and includes one or more structural units selected from the group represented by the following chemical formula 5.

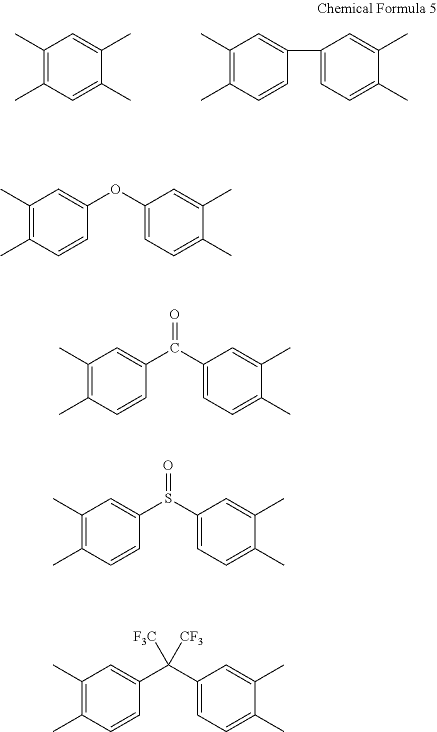

n and m are integers from 1 to 100.

It is preferred that a number average molecular weight of the soluble liquid crystal thermosetting oligomer is 500 to 15,000. When the molecular weight of the soluble liquid crystal thermosetting oligomer is less than 500, physical properties may be brittle due to an increase in crosslinking density, and when the molecular weight of the soluble liquid crystal thermosetting oligomer exceeds 15,000, it may be disadvantageous when being impregnated into a reinforcing agent due to an increase in viscosity of a solution.

The soluble liquid crystal thermosetting oligomer may additionally include an epoxy resin in a main chain thereof. The epoxy resin may be included in an amount of 0.01 to 50 parts by weight based on 100 parts by weight of the soluble liquid crystal thermosetting oligomer. Further, the epoxy resin used is not particularly limited, for example, a bisphenol-A type epoxy resin, a naphthalene-modified epoxy resin, a cresol novolac epoxy resin, a rubber-modified epoxy resin, etc. It is possible to use these materials independently or by mixing at least two of them but not particularly limited thereto.

The soluble liquid crystal thermosetting resin having the above structure has a much lower coefficient of thermal expansion than an epoxy resin used as an insulating polymer in the prior art and is advantageous in forming a hybrid composite structure with other components included in the insulating composition since it includes various functional groups.

Further, the present invention may include a metal alkoxide together with the graphene oxide to reduce the coefficient of thermal expansion of the insulating composition. A metal of the metal alkoxide may be at least one selected from the group consisting of Ti, Al, Ge, Co, Ca, Hf, Fe, Ni, Nb, Mo, La, Re, Sc, Si, Ta, W, Y, Zr, and V.

The metal alkoxide in accordance with the present invention includes a reaction group which can form a covalent bond with the soluble liquid crystal thermosetting oligomer represented by the chemical formula 1, for example, at least one selected from the group consisting of a vinyl group, an acrylic group, a metacrylic acid, a mercapto group, and combinations thereof.

The metal alkoxide having a reaction group which can form a covalent bond may be, for a concrete example, compounds represented by the following chemical formulas 6 to 9 but not particularly limited thereto.

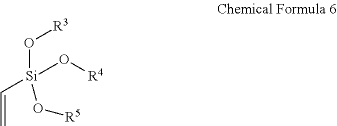

In the formula, R3 to R5 may be alkyl groups independently having at least one carbon atom, for example, a methane group, an ethane group, a propane group, etc.

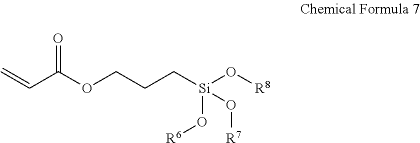

In the formula, R6 to R8 may be alkyl groups independently having at least one carbon atom, for example, a methane group, an ethane group, a propane group, etc.

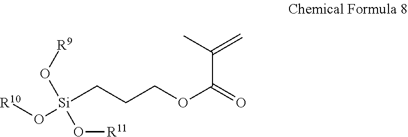

In the formula, R9 to R11 may be alkyl groups independently having at least one carbon atom, for example, a methane group, an ethane group, a propane group, etc.

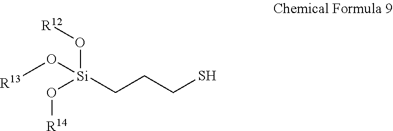

In the formula, R12 to R14 may be alkyl groups independently having at least one carbon atom, for example, a methane group, an ethane group, a propane group, etc.

The metal alkoxide having a reaction group which can form a covalent bond may be used independently or the metal alkoxides having several reaction groups may be mixed to be used.

It is preferred that the metal alkoxide is included in an amount of 0.01 to 50 parts by weight based on the weight of the soluble liquid crystal thermosetting oligomer. When the content of the metal alkoxide is less than 0.01 parts by weight, a reduction in the coefficient of thermal expansion is insufficient. Further, when the content of the metal alkoxide exceeds 50 parts by weight, it is not preferred since the insulating composition breaks easily and cracks.

The present invention also may include a short fiber with an average fiber length of 5 nm to 1000 μm. The short fiber in accordance with the present invention means a short fiber with a fiber length of 5 nm to 1000 μm. When the length of the short fiber is less than 5 nm, it is not preferred since improvement of mechanical properties is slight due to a low slenderness ratio. Further, when the length of the short fiber exceeds 1000 μm, it is not preferred since a reinforcing effect doesn't occur properly due to a difficulty of mixing and non-uniform distribution of the short fiber when dispersing the short fiber in the insulating polymer resin. The short fiber may be at least one selected from the group consisting of a glass fiber, kevlar, a carbon fiber, and alumina.

It is preferred that the short fiber is included in an amount of 0.01 to 50 parts by weight based on the mixed weight of the soluble liquid crystal thermosetting oligomer, the metal alkoxide, and the graphene oxide. When the content of the short fiber is less than 0.01 parts by weight, a mechanical reinforcing effect doesn't occur. Further, when exceeding 50 parts by weight, it is not preferred since several problems may occur when processing a substrate due to a difficulty of dispersion.

The insulating composition of the present invention may additionally include one or more additives such as a filler, a softener, a plasticizer, a lubricant, an antistatic agent, a coloring agent, an antioxidant, a heat stabilizer, a light stabilizer, and a UV absorber according to the need.

Further, the present invention may provide a substrate including an insulating layer using an insulating composition which includes a graphene oxide and an insulating material including the same; and a polar solvent having a solvent polarity index (P) of greater than 5.5.

A thickness of the insulating layer may be 5 nm to 1000 μm. Therefore, the insulating layer in accordance with the present invention can be formed with a fine thickness compared to an insulating layer manufactured using conventional composition and method.

Further, the insulating layer may be an insulating prepreg or an insulating film.

In the insulating composition in accordance with the present invention, a short fiber-dispersed insulating resin is prepared by adding a short fiber in a solution prepared by mixing a graphene oxide and an insulating material including the same, a polar solvent having a solvent polarity index (P) of greater than 5.5, a soluble liquid crystal thermosetting resin (LCT resin), and a metal alkoxide.

Next, a prepreg, which is a short fiber-reinforced insulating material, is prepared by impregnating the insulating resin in an appropriate reinforcing agent. The reinforcing agent used at this time is not particularly limited, for example, woven glass cloth, woven alumina glass cloth, nonwoven glass fabric, nonwoven cellulose fabric, woven carbon cloth, and polymer cloth. Further, a method of impregnating the insulating composition in the reinforcing agent may be dip coating, roll coating, etc, and other typical impregnation methods may be used.

Continuously, the prepreg is dried at appropriate temperature and time, laid up with a copper foil etc, and cured to be formed into a sheet.

Further, since the insulating composition in accordance with the present invention has high adhesive strength to the copper foil and exhibits high heat resistance, low expansion, and excellent mechanical properties, it can be used as an excellent packaging material. The insulating composition can be formed into a substrate or a varnish for impregnation or coating. The composition can be applied to a printed circuit board, each layer of a multilayer substrate, a copper clad laminate (for example, RCC, CLL), and a TAB film, but the purpose of the insulating composition is not limited thereto.

Further, the present invention may provide a method for manufacturing a substrate including the step of forming an insulating layer using an insulating composition which includes a graphene oxide and an insulating material using the same; and a polar solvent having a solvent polarity index (P) of greater than 5.5.

In accordance with an embodiment of the present invention, it is preferred that the insulating layer is formed by an inkjet printing method.

The kind of ink typically used in inkjet printing is limited to a metal ink which forms an electrode layer and a polymer insulator which forms an insulating layer. However, in the present invention, it is possible to cover a composition including an insulating material such as a graphene oxide as well as a polymer insulator by using an inkjet printing method.

Particularly, since the graphene oxide can secure dispersibility on a specific solvent, it is a dramatic material that can overcome aggregation in the conventional inkjet printing method. Further, if utilizing an inkjet printing process, since it is possible to implement both of a bulk pattern and a fine or ultrafine pattern, utilization of the present invention is very high. Particularly, by forming mixtures and compounds of the graphene oxide and other insulating materials, the kind of insulating layers that can be implemented becomes very diverse.

### Embodiment

### Test of Securing Dispersibility of Graphene Oxide

In order to fine an appropriate solvent that can secure dispersibility of a graphene oxide used as an insulating material of the present invention, the graphene oxide (Hoffman graphene oxide having a carbon/oxygen ratio of 10/1 and including epoxy and alcohol functional groups on a surface) is ultrasonic dispersed in solvents in the following Table 1.

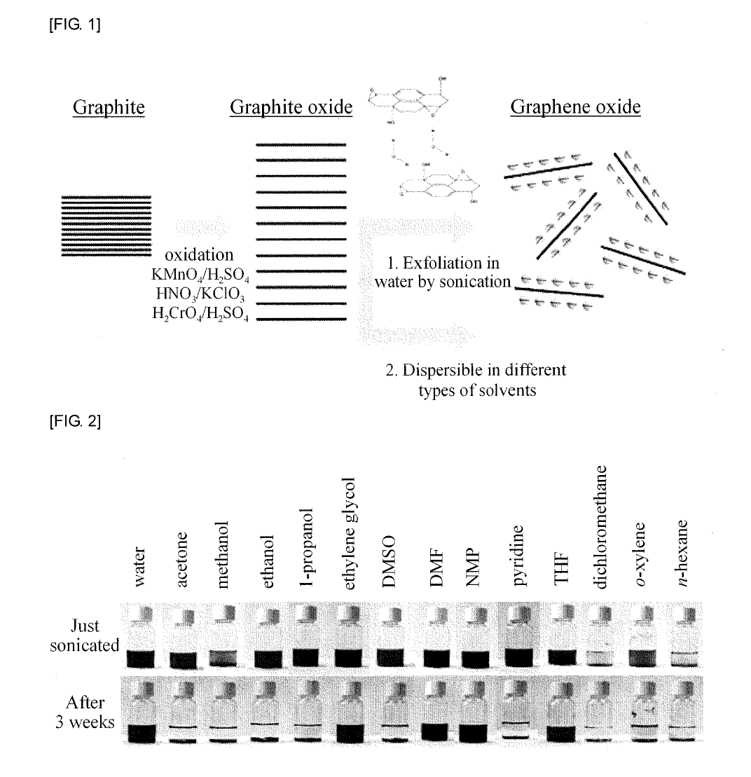

The dispersibility is observed with the naked eye right after dispersing the graphene oxide in each solvent and after three weeks, and the results of the observation are shown in the following FIG. 2.

TABLE 1

| No. | Polarity Index | Solvent |
|---|---|---|
| 1 | 9.0 | water |
| 2 | 5.4 | acetone |
| 3 | 5.1 | methanol |
| 4 | 5.2 | ethanol |
| 5 | 4.0 | 1-prophanol |
| 6 | 6.9 | Ethylene glycol |
| 7 | 7.2 | dimethylsulfoxide (DMSO) |
| 8 | 6.4 | dimethyl formamide (DMF) |
| 9 | 7.0 | N-methylpyrrolidone (NMP) |
| 10 | 5.3 | pyridine |
| 11 | 6.0 | tetrahydrofuran (THF) |
| 12 | 3.1 | dichloromethane |
| 13 | 2.5 | o-xylene |
| 14 | 0.0 | n-hexane |

As in the results of the following FIG. 2, in the solvents having a polarity index of greater than 5.5, the dispersibility of the graphene oxide is maintained as it is right after dispersing the graphene oxide and after three weeks.

However, in the solvents having a polarity index of less than 5.5, the dispersibility of the graphene oxide is secured right after dispersing the graphene oxide but the graphene oxide is not dispersed well after three weeks.

From these results, it is possible to know that the dispersibility can be secured by using a solvent having a polarity index of greater than 5.5 when the graphene oxide in accordance with the present invention is used as an insulating material.

### Embodiment 1

### Manufacture of Substrate

A soluble liquid crystal thermosetting oligomer (number average molecular weight 7500-9000) is prepared by mixing and reacting aminophenol, isophthalic acid, naphthoic acid, hydroxybenzoic acid, and nadimido benzoic acid at a molar ratio of 2:1:2:2:2 in a 100 ml flask with a condenser and a stirrer.

100 g of the soluble liquid crystal thermosetting oligomer and 25 g of N-methyl-2-pyrrolidone (NMP) having a solvent polarity index (P) of 7.0 are put and stirred while gradually increasing a temperature to 90° C. to dissolve the soluble liquid crystal thermosetting oligomer.

Continuously, trimethoxyvinyl silane and tetraethylorthosilicate as metal alkoxides are mixed in the soluble liquid crystal thermosetting oligomer solution at a molar molecular ratio of 1:5 and added in an amount of 30 parts by weight based on the soluble liquid crystal thermosetting oligomer.

Further, 2 parts by weight of a graphene oxide (carbon/oxygen ratio=10/1) is added based on the mixed weight of the soluble liquid crystal thermosetting oligomer and the metal alkoxides and stirred to prepare an insulating composition (viscosity 15 cps @25° C.).

The prepared insulating composition is applied on a printed circuit board having a circuit pattern with a thickness of 1.7 μm by an inkjet printing method to form an insulating layer.

### Comparative Example 1

A soluble liquid crystal thermosetting oligomer (number average molecular weight 7500-9000) is prepared by mixing and reacting aminophenol, isophthalic acid, naphthoic acid, hydroxybenzoic acid, and nadimido benzoic acid at a molar ratio of 2:1:2:2:2 in a 100 ml flask with a condenser and a stirrer.

An insulating composition is prepared by putting and stirring 100 g of the soluble liquid crystal thermosetting oligomer and 25 g of N-methyl-2-pyrrolidone (NMP) while gradually increasing a temperature to 90° C. to dissolve the soluble liquid crystal thermosetting oligomer.

An insulating layer is formed by applying the prepared insulating composition on a printed circuit board having a circuit pattern with a thickness of 170 μm by a casting method.

### Comparative Example 2

A soluble liquid crystal thermosetting oligomer (number average molecular weight 7500-9000) is prepared by mixing and reacting aminophenol, isophthalic acid, naphthoic acid, hydroxybenzoic acid, and nadimido benzoic acid at a molar ratio of 2:1:2:2:2 in a 100 ml flask with a condenser and a stirrer.

100 g of the soluble liquid crystal thermosetting oligomer and 25 g of N-methyl-2-pyrrolidone (NMP) are put and stirred while gradually increasing a temperature to 90° C. to dissolve the soluble liquid crystal thermosetting oligomer.

Continuously, trimethoxyvinyl silane and tetraethylorthosilicate as metal alkoxides are mixed in the soluble liquid crystal thermosetting oligomer solution at a molar molecular ratio of 1:5 and added in an amount of 30 parts by weight based on the soluble liquid crystal thermosetting oligomer.

The insulating composition is applied on a printed circuit board having a circuit pattern with a thickness of 170 μm by a casting method to form an insulating layer.

### Reference Example

Except for forming an insulating layer with a thickness of 170 μm by applying the insulating composition prepared in the embodiment 1 on a printed circuit board having a circuit pattern not by an inkjet method but by a casting method, a printed circuit board is manufactured by the same process as the embodiment 1.

### Experimental Example 1

### Checking of Thermal Characteristics

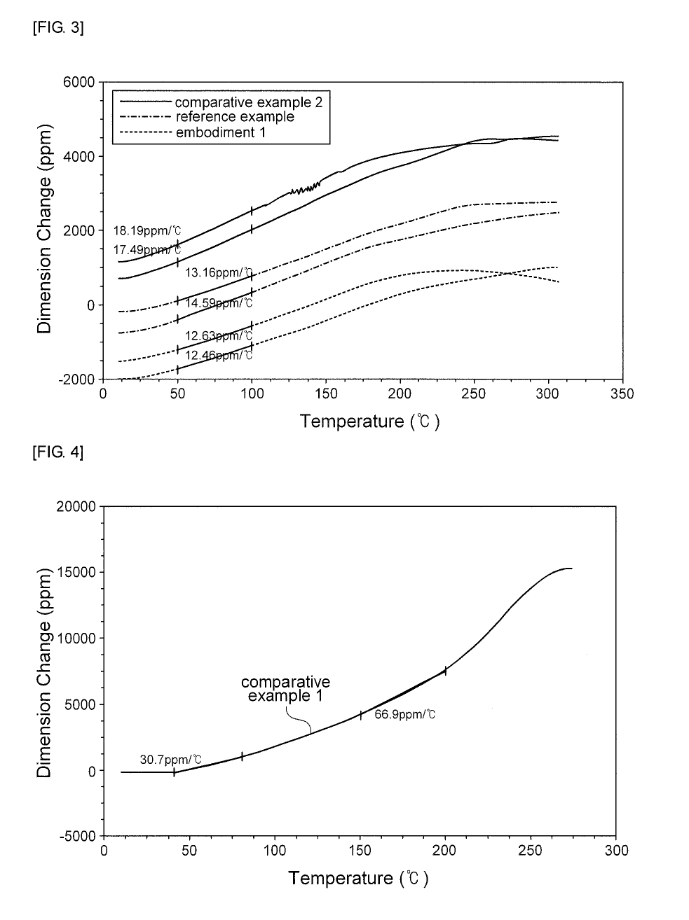

The insulating layer films manufactured in the embodiment 1 and the comparative examples 1 and 2 and the prepreg obtained in the reference example are compressed to be formed into films, and thermal characteristics and coefficient of thermal expansion (CTE) thereof are measured using TA TMA Q400. The results of the measurement are shown in the following Table 2 and FIGS. 3 and 4. The measurement was performed at a heating rate of 10° C./min in a state of being purged with nitrogen. A low temperature coefficient of thermal expansion is a mean value measured in the range of 50 to 100° C.

TABLE 2

| | | CTE × (10⁻⁶/° C.) | | | |
|---|---|---|---|---|---|
| | Thickness of | 50~100° C. | 50~100° C. | | CTE |
| Unit: μm/° C. | insulating | first | second | 50~100° C. | reduction |
| (ppm/° C.) | layer (μm) | measurement | measurement | average | rate |
| Comparative | 170 | 30.7 | — | 30.7 | 0 (reference) |
| example 1 | | | | | |
| Comparative | 170 | 18.19 | 17.49 | 17.8 | 42% |
| example 2 | | | | | |
| Reference | 170 | 13.16 | 14.59 | 13.9 | 55% |
| example | | | | | |
| Embodiment | 1.7 | 12.63 | 12.46 | 12.5 | 59% |

As in the results of the above Table 1, in the comparative examples 1 and 2 that don't include the graphene oxide of the present invention as an insulating material, even through the polar solvents having a solvent polarity index (P) of greater than 5.5 are used, the thermal characteristics are deteriorated compared to the embodiment of the present invention.

Further, in the reference example using the same insulating composition, since the insulating material is coated not by an inkjet method but by a casting method, the insulating layer is formed with a very large thickness beyond the scope of the present invention. In contrast, since the insulating layer in accordance with the present invention is coated with a thickness of 1.7 μm by an inkjet method, it is possible to print an ultrafine line width pattern according to miniaturization and thinning desired by the present invention.

### Experimental Example 2

### Printing Characteristics of Insulating Layer and Substrate and Manufacture of Large Panel

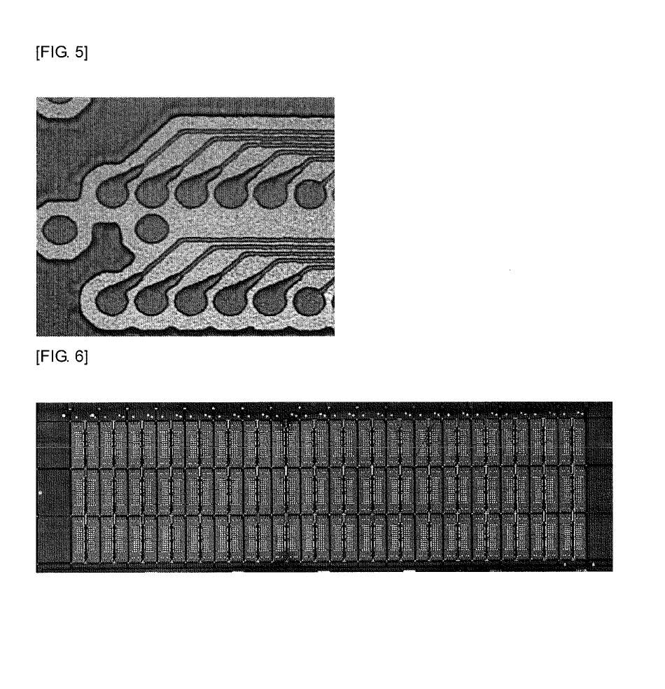

It is checked through observation of an optical microscope whether printing of the insulating layer formed according to the embodiment and the substrate including the same is actually implemented or not, and the results are shown in the following FIGS. 5 and 6.

As in the results of the following FIG. 5, as the result of checking by an optical microscope, it is checked that 1.7 μm wiring of the insulating layer is formed, and as in the results of the following FIG. 6, it is verified whether a 504 mm×225 mm large substrate printed panel can be manufactured or not.

According to the present invention, it is possible to provide an insulating composition including a specific solvent that can secure dispersibility of a graphene oxide while including the graphene oxide having excellent insulating and mechanical properties.

Further, the present invention can provide a substrate including a fine insulating layer pattern as well as a bulk insulating layer pattern and a method for manufacturing the same by using an insulating composition to overcome an aggregation problem in the conventional inkjet printing method.

Further, the present invention can implement various types of insulating layers by adding other insulating materials to a graphene oxide to form compounds and mixtures.

What is claimed is:

1. An insulating composition comprising:
a graphene oxide and an insulating material comprising the same; and
a polar solvent having a solvent polarity index (P) of greater than 5.5.

2. The insulating composition according to claim 1, wherein an average particle size of the graphene oxide is 10 nm to 50 μm.

3. The insulating composition according to claim 1, wherein the graphene oxide has at least one functional group among a hydroxyl group, a carboxyl group, and an epoxy group on its surface and edge.

4. The insulating composition according to claim 1, wherein a ratio of carbon atoms to oxygen atoms (carbon/oxygen ratio) of the graphene oxide is 1 to 20.

5. The insulating composition according to claim 1, wherein the polar solvent comprises one or more functional groups selected from nitrile, oxide, amide, pyrrolidone, sulfoxide, and diol.

6. The insulating composition according to claim 1, wherein the polar solvent is one or more selected from the group consisting of acetonitrile, tetrahydrofuran (THF), acetic acid, dimethylformamide (DMF), N-methylpyrrolidone (NMP), dimethyl sulfoxide (DMSO), ethylene glycol, and water.

7. The insulating composition according to claim 1, wherein the insulating composition has a viscosity of less than 250 cps at room temperature (25° C.).

8. The insulating composition according to claim 1, wherein the insulating material is one or more selected from a soluble liquid crystal thermosetting oligomer, a metal alkoxide, and a short fiber.

9. The insulating composition according to claim 8, wherein the soluble liquid crystal thermosetting oligomer is a compound represented by the following chemical formula 2: 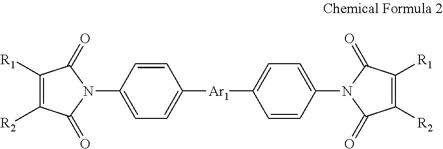
In the formula, R₁ and R₂ are CH₃ or H, and at least one of R₁ and R₂ is CH₃,
Ar₁ is a bivalent aromatic organic group having a molecular weight of less than 5,000, which comprises one or more structural units selected from the group consisting of ester, amide, ester amide, ester imide, and ether imide, and
Ar₁ comprises one or more structural units selected from the group represented by the following chemical formula 3: 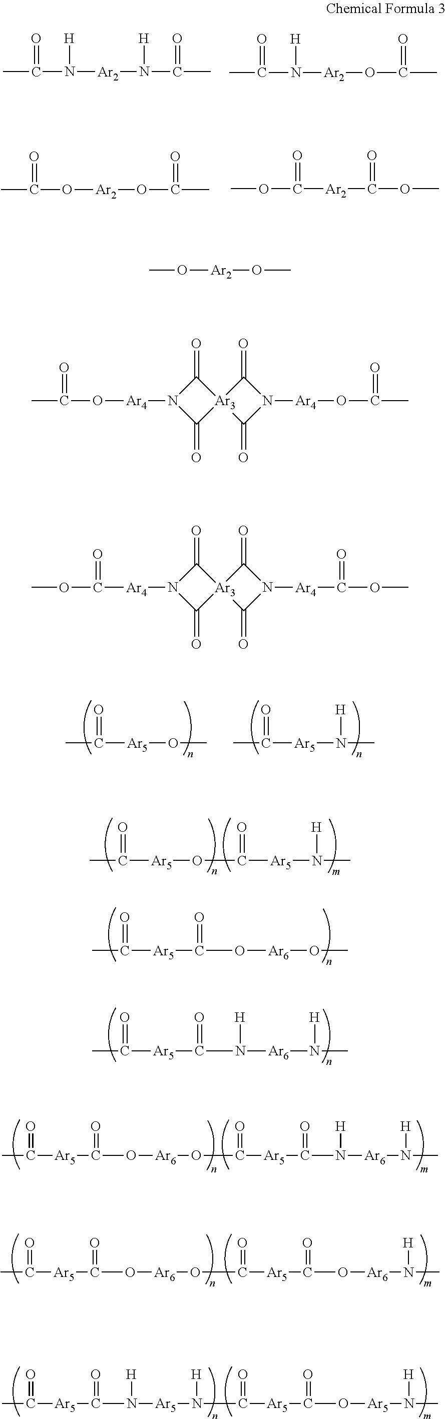
In the formula, Ar₂, Ar₄, Ar₅, and Ar₆ are bivalent aromatic organic groups and comprise one or more structural units selected from the group represented by the following chemical formula 4,
Ar₃ is a tetravalent aromatic organic group and comprises one or more structural units selected from the group represented by the following chemical formula 5, and
n and m are integers from 1 to 100:

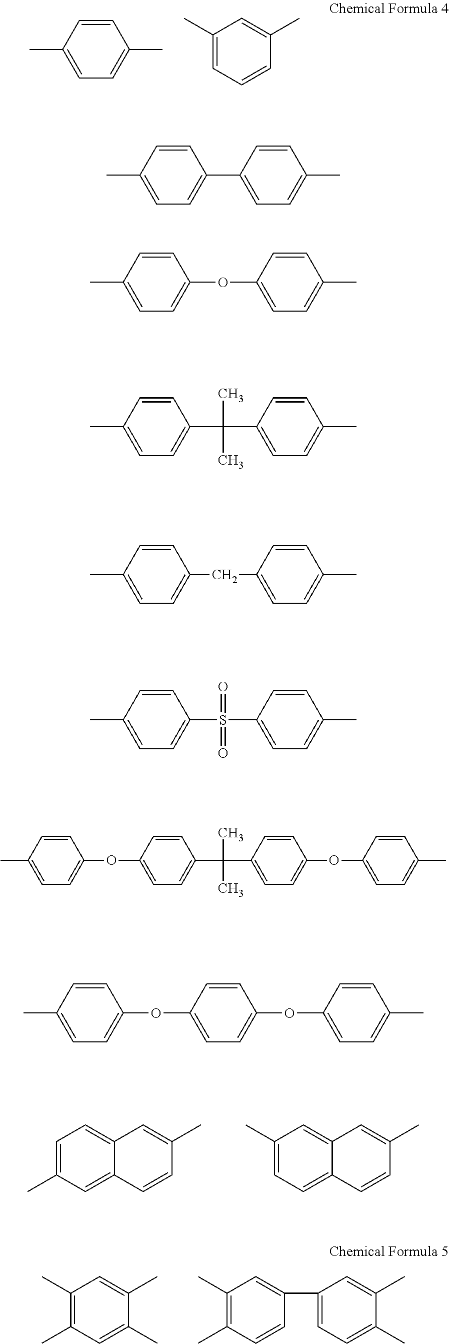

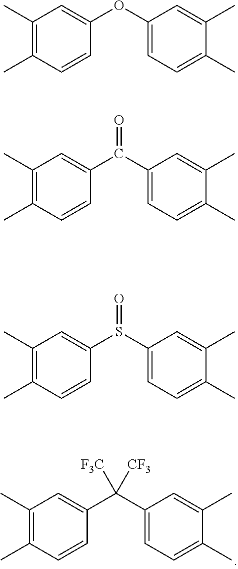

10. The insulating composition according to claim 8, wherein a number average molecular weight of the soluble liquid crystal thermosetting oligomer is 500 to 15,000.

11. The insulating composition according to claim 8, wherein the soluble liquid crystal thermosetting oligomer additionally comprises an epoxy resin in a main chain.

12. The insulating composition according to claim 11, wherein the epoxy resin is included in an amount of 0.01 to 50 parts by weight based on 100 parts by weight of the soluble liquid crystal thermosetting oligomer.

13. The insulating composition according to claim 8, wherein a metal of the metal alkoxide is one or more selected from the group consisting of Ti, Al, Ge, Co, Ca, Hf, Fe, Ni, Nb, Mo, La, Re, Sc, Si, Ta, W, Y, Zr, and V.

14. The insulating composition according to claim 8, wherein the short fiber has a fiber length of 5 nm to 1000 μm.

15. The insulating composition according to claim 14, wherein the short fiber is one or more selected from the group consisting of glass fibers, Kevlar, carbon fibers, and alumina.

16. A substrate comprising an insulating layer using an insulating composition according to claim 1.

17. The substrate according to claim 16, wherein a thickness of the insulating layer is 5 nm to 1000 μm.

18. The substrate according to claim 16, wherein the insulating layer is an insulating prepreg or an insulation film.

19. A method for manufacturing a substrate comprising forming an insulating layer by using an insulating composition according to claim 1.

20. The method for manufacturing a substrate according to claim 19, wherein the insulating layer is formed using the insulating composition by an inkjet printing method.

21. The method for manufacturing a substrate according to claim 20, wherein the insulating composition has a viscosity of less than 250 cps at room temperature (25° C.).
